(19) United States
(12) Patent Application Publication
(10) Pub. No.: US 2014/0021397 A1
(43) Pub. Date: Jan. 23, 2014

(54) SEALING ELEMENT FOR A GATE VALVE

(71) Applicant: Udaykumar Painter, Bangalore (IN)

(72) Inventor: Udaykumar Painter, Bangalore (IN)

(73) Assignee: Weir Minerals (India) Private Limited, Bangalore, KA (IN)

(21) Appl. No.: 13/981,911

(22) PCT Filed: Jan. 23, 2012
(86) PCT No.: PCT/AU2012/000043

§ 371 Date: Oct. 9, 2013

(30) Foreign Application Priority Data
Jan. 28, 2011 (IN) 265/CHE/2011
Feb. 1, 2011 (AU) 2011900299

(51) Int. Cl. F16K 3/02

(52) U.S. Cl. CPC F16K 3/0281
USPC 251/328

(57) ABSTRACT

An elastomeric sealing element for a gate valve is described, the sealing element being generally annular in shape and having a mounting region and an abutting region; and a narrowed portion being provided between the mounting region and the abutting region to allow deformation of the sealing element to facilitate introduction of a gate between the sealing element and another sealing element; and wherein the narrowed region of the sealing element includes an external annular recess disposed around an outer surface of the sealing element. Gate valves incorporating sealing elements are also described.

### TECHNICAL FIELD

The present invention relates generally to a sealing element for a gate valve and to a gate valve incorporating one or more of these sealing elements. Gate valves are also known as slide valves or as guillotine valves. In pipelines used for the passage of fluids such as, for example, mineral slurries, valves of this type may be fitted to the pipeline and used to close off the fluid flow.

### BACKGROUND

Gate valves include a valve body which can be fitted to a pipeline and having a gate or blade which is moveable between the open and closed position, whereby in the closed position fluid flow through the valve body is inhibited. The gate can be actuated manually, or powered by hydraulic, pneumatic or electric power sources.

### SUMMARY OF THE DISCLOSURE

In a first aspect, embodiments are disclosed of a sealing element for a gate valve, the sealing element being generally annular in shape and having a mounting region and an abutting region; and

a narrowed portion being provided between the mounting region and the abutting region to allow deformation of the sealing element to facilitate introduction of a gate between the sealing element and another sealing element; and

wherein the narrowed region of the sealing element includes an external annular recess disposed around an outer surface of the sealing element

In certain embodiments, the external annular recess includes a generally convex portion.

In certain embodiments, the narrowed region of the sealing element includes an internal annular recess disposed around an inner surface of the sealing element.

In certain embodiments, the internal annular recess includes a generally concave portion.

In certain embodiments, the sealing element further includes an annular ridge disposed around the outer surface of the mounting region of the sealing element.

In certain embodiments, the abutting region of the sealing element terminates in a chamfered edge.

In certain embodiments, the mounting region includes an annular stiffening member.

In certain embodiments, the abutting region includes an annular stiffening member.

In certain embodiments, the radius of the convex portion is greater than the radius of the concave portion.

In a second aspect, embodiments are disclosed of a gate valve including:

a valve body,

a seal assembly mounted to said valve body and comprising two generally annular shaped elastomeric sealing elements which, when in use, are disposed side by side in abutting relation and adapted to receive a gate therebetween, each sealing element having a mounting region and an abutting region;

wherein at least one of the sealing elements is in accordance with an embodiment of the first aspect.

In certain embodiments, both sealing elements are in accordance with an embodiment of the first aspect.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

An embodiment of the present invention will now be described, by way of example only, with reference to the accompanying drawings, in which:

FIG. 1 illustrates an exemplary perspective view of a gate valve, in accordance with certain embodiments;

FIG. 2 illustrates a cross sectional view of the body of the gate valve of FIG. 1, with some of the features of the sealing element not shown for ease of illustration; and

FIG. 3 illustrates a cross sectional view of a sealing element for a gate valve, in accordance with certain embodiments.

### DETAILED DESCRIPTION

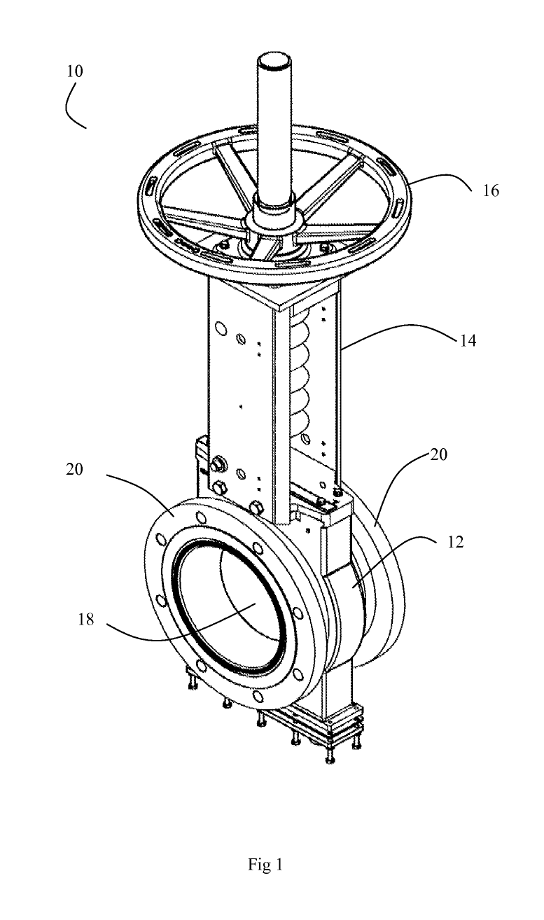

Referring to FIG. 1, a gate valve 10 is shown comprising a valve body 12 to which is mounted an actuator 14 for controlling movement of a gate 18. In the example shown, the actuator 14 comprises a manually controlled turning handle 16 which turns a threaded shaft (not shown). The gate 18 is mounted to the threaded shaft and moves upwards or downwards depending upon the direction of rotation of the shaft.

In use, the valve body 12 is mounted between two sections of a pipeline which each have flanged end regions which mate with the flanges 20 that are located on opposing sides of the valve body 12. In use, fluid passes through the pipeline and through a bore in the valve body 12. The flanges 20 are mounted to the adjacent pipeline sections by way of a number of bolts. In FIG. 1, the gate 18 is shown in the closed position in which it is obstructing the bore of the valve body 12 and thereby obstructing flow of fluid in the pipeline.

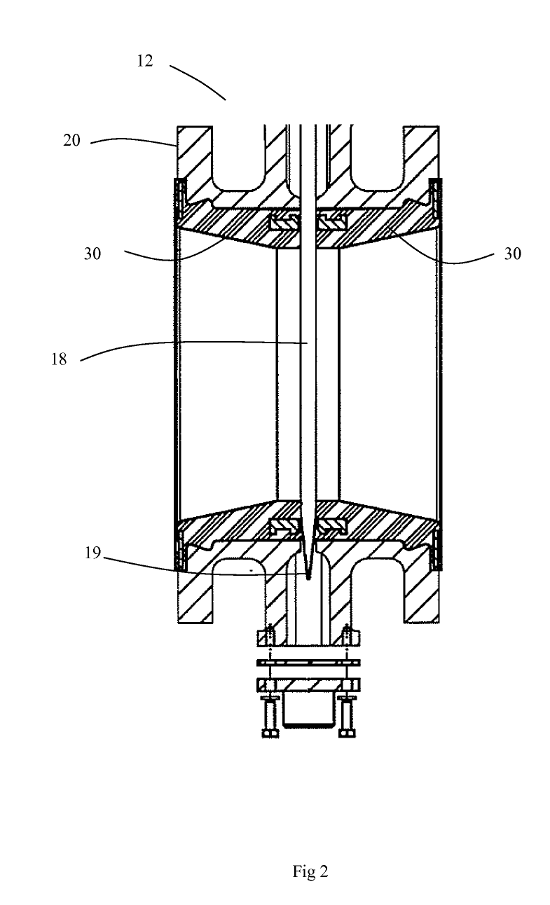

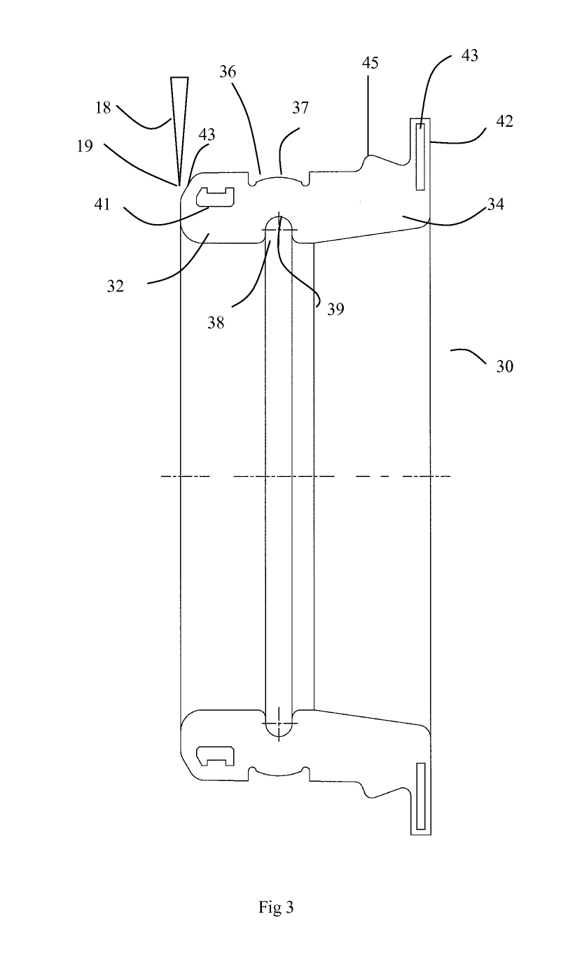

Referring to FIG. 2, the valve 10 includes two like annular sealing elements 30, mounted into the valve body 12, positioned side-by-side in abutting relation, and disposed respectively upstream and downstream with respect to the gate 18. The sealing elements 30 are manufactured from an elastomeric material and are interchangeable. Each sealing element 30 also includes internal and external circumferential, annular recesses which are not shown in FIG. 2 for ease of illustration. A sealing member 30 is shown in full detail in FIG. 3.

In FIG. 2, the gate 18 is shown in the lowered, closed position in which the flow of fluid through the bore of the valve body 12 is obstructed. By rotation of handle 16, the gate 18 can be moved to a raised position in which the gate 18 is completely withdrawn from between the sealing elements 30 (as shown in FIG. 3). As the gate 18 is withdrawn, the sealing elements 30 expand to abut one another about their respective inner-facing periphery, in order to provide a continuous fluid-tight flow path through the bore of the valve body 12.

To close the valve, the handle 16 is rotated in the opposite direction in order to lower the gate 18 and to force it downward between the two sealing elements 30. As shown in FIGS. 2 and 3, the lower edge of gate 18 terminates in a tapered knife-edge 19. The knife-edge 19 aids the penetration of the gate 18 between the sealing elements as the gate 18 is lowered.

The sealing elements 30 are configured for controlled deformation to facilitate introduction of the gate 18 between the sealing elements 30 as the gate 18 advances, thus providing adequate sealing of the fluid material passing through the pipeline.

Referring to FIG. 3, one of sealing elements 30 is shown in enlarged detail. The sealing element 30 is of uniform radial cross section. The sealing element 30 includes a mounting region 34 by which the device is mounted to the valve body which includes a lip 42 in which is embedded a stiffening member in the form of a ring 43. The ring 43 spreads load and assists in maintaining integrity and deformity of the flange lip 42, to avoid leakage. The ring can be made of a standard material such as mild steel, which will be encased in the elastomeric material of the sealing element 30. The ring 43 is arranged to distribute a constant load force about the entire flange 42 of the body 12, which reduces the possibility of any variation in the load pressure at one point along the circumference which may in turn allow leakage of fluid to occur. An annular ridge 45 provided about the outer circumferential surface of sealing element 30 engages with a corresponding annular recess in the valve body 12 so as to retain sealing element 30 in the valve body 12 prior to installation and fastening of adjacent pipe ends onto the flanges 20. The annular ridge 45 assists with interlocking the valve body 12 and sealing element 30 during use, especially during transportation and any shocks experienced by the valve 10.

The sealing element 30 further includes an abutting region 32 which includes a stiffening member in the form of metal ring 41. When the valve 10 is in the open position, the end face of abutting region 32 abuts against a like face of the abutting region 32 of an opposing, identical sealing element 30 in order to provide a fluid tight passage through the bore of the valve body 12.

The sealing element 30 includes a narrowed portion which includes an external annular recess 36 which has a convex portion 37 located therein and an internal annular recess 38 which includes a concave portion 39. The radius of the convex portion 37 is greater than the radius of the concave portion 39. In the embodiment shown, the convex portion 37 is located in vertical alignment with the concave portion 39.

The lower region of the gate 18 is shown schematically in the raised position in association with the sealing element 30. As gate 18 is lowered, it engages with the abutment region 32 of the sealing element 30 and causes a generally lateral deformation of the sealing element 30 and of another identical adjacent, sealing element 30 (not shown), to allow the gate 18 to become inserted therebetween.

The narrowed portion of the sealing element 30 allows an amount of deflection and compression in that region of the sealing element to accommodate the sliding introduction of the gate 18. The internal annular recess 38 becomes compressed laterally in an outwardly direction as the gate 18 moves downwardly. The external annular recess 36 provides a space where the compressed elastomeric material can expand into. The radius of convex portion 37 becomes more arched as the gate 18 enters between the sealing elements 30.

The abutment region 32 terminates in a bevelled leading edge 43 which further facilitates entry of the gate 18 between two sealing elements 30 in its downward motion to close the pipeline.

The sealing elements 30 are formed by moulding and curing elastomeric material and embedding the metal rings 41, 43 in the elastomeric material. The properties of the elastomeric material used may be similar to that used in the manufacture of hard wearing rubber articles, for example automobile tires.

In the embodiment described above, the internal annular recess included a concave portion and the external annular recess included a convex portion. In further embodiments this configuration may be reversed, so that the internal annular recess includes a convex portion and the external annular recess includes a concave portion. In some embodiments, both of the internal and external annular recesses include convex portions.

In the embodiment described above, the internal annular recess was located in vertical alignment with the external annular recess. In other embodiments, these recesses may not be in vertical alignment, but may be offset with respect to one another.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A sealing element for a gate valve, the sealing element being generally annular in shape and having a mounting region and an abutting region; and
a narrowed portion being provided between the mounting region and the abutting region to allow deformation of the sealing element to facilitate introduction of a gate between the sealing element and another sealing element; and
wherein the narrowed region of the sealing element includes an external annular recess disposed around an outer surface of the sealing element

2. A sealing element according to claim 1, wherein the external annular recess includes a generally convex portion.

3. A sealing element according to any one of the preceding claims, wherein the narrowed region of the sealing element includes an internal annular recess disposed around an inner surface of the sealing element.

4. A sealing element according to claim 3, wherein the internal annular recess includes a generally concave portion.

5. A sealing element according to claim 3, wherein the internal annular recess is located in vertical alignment with the external annular recess.

6. A sealing element according to any one of the preceding claims, further including an annular ridge disposed around the outer surface of the mounting region of the sealing element.

7. A sealing element according to any one of the preceding claims, wherein the abutting region of the sealing element terminates in a chamfered edge.

8. A sealing element according to any one of the preceding claims, wherein the mounting region includes an annular stiffening member.

9. A sealing element according to any one of the preceding claims, wherein the abutting region includes an annular stiffening member.

10. A sealing element according to claim 2, wherein the radius of the convex portion is greater than the radius of the concave portion defined in claim 4.

11. A gate valve including:
a valve body,
a seal assembly mounted to said valve body and comprising two generally annular shaped elastomeric sealing elements which, when in use, are disposed side by side in abutting relation and adapted to receive a gate therebetween, each sealing element having a mounting region and an abutting region;
wherein at least one of the sealing elements is in accordance with any one of claims 1 to 10.

12. A gate valve according to claim 11 wherein both sealing elements are in accordance with any one of claims 1 to 10.
